(19) United States
(12) Patent Application Publication
(10) Pub. No.: US 2008/0102264 A1
(43) Pub. Date: May 1, 2008

(54) ATTACHMENT OF INTEGRATED CIRCUIT CHIP TO DISPLAY SCREEN

(75) Inventors: Kinzy Jones, Hollywood, FL (US); Habib Amirzadeh, Weston, FL (US); Julio C. Castaneda, Coral Springs, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc., Schaumburg, IL (US)

(21) Appl. No.: 11/554,739

(22) Filed: Oct. 31, 2006

(51) Int. Cl. B32B 7/04; H01S 4/00

(52) U.S. Cl. 428/221; 29/592.1

(57) ABSTRACT

A display (200) that includes a first screen layer (205) having a first dimension (230) and a second screen layer (210) having a first side (211) bonded to a first side (206) of the first screen layer. The second screen layer can have a second dimension (225) that is greater than the first dimension, thereby defining a portion (235) of the second layer that extends beyond the first layer. The display also can include at least one integrated circuit chip (245) attached to the portion of the second layer. The integrated circuit chip can include, for example, a display driver. A stiffening component (250) can be positioned, at least in part, over the integrated circuit chip. The stiffening component also can be positioned over at least a substantial part of the defined portion of the second layer.

### BACKGROUND OF THE INVENTION

1. Field of the Invention

The present invention generally relates to displays and, more particularly, to display screens to which integrated circuits are attached.

2. Background of the Invention

Modern electronic devices oftentimes include liquid crystal displays (LCDs), an example of which is shown in FIG. 1. An LCD 100 generally comprises two layers 105, 110, or panes, of glass that are bonded to one another in a stacked manner. In addition, a top polarizer 115 may be attached to the top layer 105, and a bottom polarizer (not shown) may be attached to the bottom layer 110. One of the layers of glass, which in this example is the bottom layer 110, typically has a surface area greater than the other layer 105 so as to include a portion 135 which extends beyond an end 140 of the other layer 105. Ceramic chips 145 comprising display driver integrated circuits are typically attached to the portion 135 using an adhesive, such as epoxy.

Because the portion 135 of the bottom layer 110 remains un-bonded to additional support structure, such as the top layer 105, the top polarizer 115 or the bottom polarizer, the portion 135 has less resistance to bending than the remaining portion of the bottom layer 110. When the LCD 100 receives an impact, the force of such impact often causes the portion 135 of the bottom layer 110 to bend enough to crack or otherwise damage the ceramic chips 145, thereby rendering the LCD 100 defective.

### SUMMARY OF THE INVENTION

The present invention relates to a display that includes a first screen layer having a first dimension and a second screen layer having a first side bonded to a first side of the first screen layer. The second screen layer can have a second dimension that is greater than the first dimension, thereby defining a portion of the second layer that extends beyond the first layer. The display also can include at least one integrated circuit chip attached to the portion of the second layer. The integrated circuit chip can include, for example, a display driver. A stiffening component can be positioned, at least in part, over the integrated circuit chip. The stiffening component also can be positioned over at least a substantial part of the defined portion of the second layer. In one arrangement, the integrated circuit chip can be encapsulated between the stiffening component and the portion of the second layer. The stiffening component can have a resistance to bending that is approximately equal to a bending resistance of the first screen layer.

The display also can include a barrier attached to the portion of the second layer. The stiffening component can be deposited into a cavity defined by the barrier and the portion of the second layer. After the stiffening component is deposited into the cavity, the barrier can become an integral part of the stiffening component. A combination of the first dimension of the first screen layer and a third dimension of the stiffening component can be substantially equal to the second dimension of the second screen layer.

A polarizer layer can be attached to a second side of the first screen layer. For example, a first side of the polarizer layer can be attached to a second side of the first screen layer. A thickness of the stiffening component can be substantially equal to a combined thickness of the first screen layer and the polarizer layer. Further, a top of the stiffening component can be substantially co-planar with respect to a second side of the polarizer layer. The stiffening component can have a resistance to bending that is approximately equal to a combined bending resistance of the first screen layer and the polarizer layer. In one arrangement, the stiffening component can include an epoxy, for example an ultraviolet light curable epoxy.

The present invention also relates to a method of fabricating a display. The method can include positioning a stiffening component, at least in part, over an integrated circuit chip attached to a portion of a second screen layer of a display that includes a first screen layer and the second screen layer. The method also can include selecting the stiffening component to have a resistance to bending that is approximately equal to a bending resistance of the first screen layer.

A barrier can be attached to a portion of the second layer and the stiffening component can be deposited into a cavity defined by the barrier and the portion of the second layer. Positioning the stiffening component can include depositing the stiffening component such that a thickness of the stiffening component is substantially equal to a combined thickness of the first screen layer and a polarizer layer. The polarizer layer can have a first side that is attached to a side of the first screen layer. Positioning the stiffening component also can include depositing the stiffening component such that a top of the stiffening component is substantially co-planar with respect to a second side of the polarizer layer. The method further can include attaching the polarizer layer to the first screen layer and selecting the stiffening component to have a resistance to bending that is approximately equal to a combined bending resistance of the first screen layer and the polarizer layer.

### BRIEF DESCRIPTION OF THE DRAWINGS

Preferred embodiments of the present invention will be described below in more detail, with reference to the accompanying drawings, in which:

FIG. 1 is a perspective view of a display of the prior art;

FIG. 2 is a perspective view of another display that is useful for understanding the present invention;

FIG. 3 is an enlarged section view of the display of FIG. 2, taken along section line 3-3;

FIG. 4 is another enlarged section view of the display of FIG. 2, taken along section line 3-3; and

FIG. 5 is a flowchart that is useful for understanding the present invention.

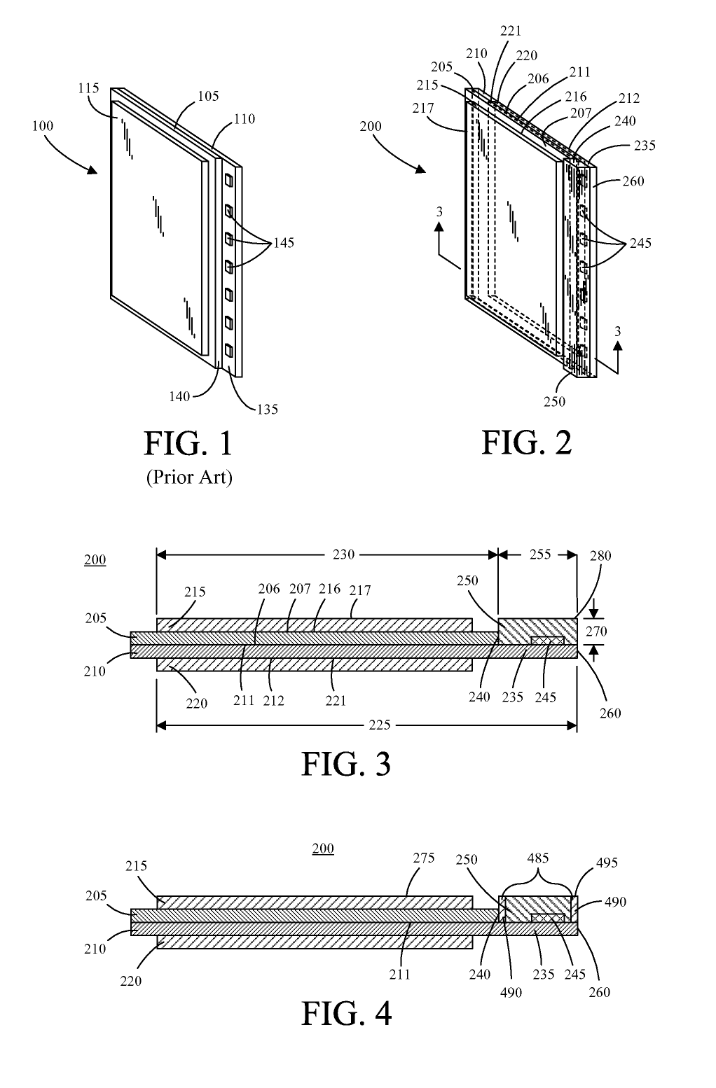

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for mounting integrated circuit chips to a display screen in a manner which provides greater durability in comparison to the prior art. FIG. 2 depicts a perspective view of a display 200 that is useful for understanding the present invention. FIG. 3 is an enlarged section view of the display 200 of FIG. 2, taken along section line 3-3. The display 200 can be a liquid crystal display (LCD), a cholesteric LCD, or any other display which comprises a plurality of screen layers and in which one or more integrated circuit chips are directly attached to one of the screen layers.

Making reference both to FIG. 2 and to FIG. 3, the display 200 can include a plurality of screen layers, for example a first screen layer 205 and a second screen layer 210. The screen layers 205, 210 can comprise glass panes, plastic or any other suitable display layer material. The screen layers 205, 210 can be bonded to one another in a stacked manner. For instance, a first side 206 of the first screen layer 205 can be bonded to a first side 211 of the second screen layer 210, for example using a suitable bonding agent. Examples of such bonding agents include, but are not limited to, epoxy, glue, chemical agents, and the like. Further, heat and/or pressure also can be applied during one or more curing processes.

In addition to the plurality of screen layers 205, 210, the display 200 optionally can include one or more polarizer layers 215, 220. For example, a first side 216 of a first polarizer layer 215 may be attached to a second side 207 of the first screen layer 205, and a first side 221 of a second polarizer layer 220 may be attached to a second side 212 of the second screen layer 210. The polarizer layers 215, 220 can be attached to the respective screen layers 205, 210 in accordance with suitable methods known in the art. For example, the polarizer layers 215, 220 can be attached using a lamination process or in any other suitable manner. The polarizer layers 215, 220 can comprise a suitable non-opaque polarizing material. An example of such a material is polycarbonate, although any non-opaque material that may be configured to polarize light can be used and the invention is not limited in this regard.

One of the screen layers, for example the second layer 210, can have at least one dimension 225 that is greater than a corresponding dimension 230 of the other layer, which in this case is the first layer 205. Accordingly, a portion 235 of the second layer 210 can extend beyond an end 240 of the first layer 205. Integrated circuit chips (hereinafter “chips”) 245 can be attached to the portion 235. The chips 245 can be attached using an adhesive, such as epoxy, or in any other suitable manner. For example, the chips 245 can be attached using an anisotropic conductive film (ACF). ACF can provide electrical conductivity between the chips 245 and the circuit traces on the second layer 210. In one arrangement, the chips 245 can be ceramic chips comprising display drivers, although the chips 245 can be any other type of suitable electronic chips and the invention is not limited in this regard.

A stiffening component 250 can be positioned over the at least part of the portion 235 of the second layer 210 and/or of the chips 245. For example, the stiffening component 250 can be positioned over a substantial part of the portion 235 so as to encapsulated each of the chips 245 between the stiffening component 250 and the portion 235. The stiffening component 250 can add rigidity to the portion 235 of the second layer 210, thereby reducing an amount by which the portion 235 bends when subjected to a force. Accordingly, use of the stiffening component 250 can reduce the risk of the chips 245 being damaged when the display receives an impact, for example as a result of being dropped.

A width 255 of the stiffening component 250 can substantially extend from the end 240 of the first screen layer 205 to an end 260 of the second screen layer 210. Accordingly, a combined width 230, 255 of the first screen layer 205 and the stiffening component 250 can be substantially equal to the width 225 of the second screen layer 210. Similarly, the stiffening component 250 can substantially extend from the first side 211 of the second screen layer 210 to a height substantially equal to the second side 207 of the first screen layer 205 or a second side 217 of the first polarizer layer 215. Accordingly, a thickness 270 of the stiffening component 250 can be substantially equal to the thickness of the first display layer 205 or a combined thickness of the first display layer 205 and the first polarizer layer 215. Further, a top 280 of the stiffening component can be substantially co-planar with respect to the second side 207 of the first screen layer 205 or the second side 217 of the polarizer layer 215, although the invention is not limited in this regard. Nonetheless, in such an arrangement, the stiffening component 250 can be selected to have a resistance to bending that is approximately equal to a bending resistance of the first screen layer 205, or a combined bending resistance of the screen layer 205 and the polarizer layer 215. When the display receives an impact, for instance due to being dropped, the consistency of height can help the display 200 absorb the energy by bending uniformly, thereby reducing the risk of damage to the display 200.

The stiffening component 250 can comprise a rigid or semi-rigid material. For example, the stiffening component can comprise a dielectric material, such as plastic. In one arrangement, the plastic can comprise an epoxy. Epoxy can be cured using ultraviolet (UV) light, a chemical process, or in any other suitable manner. Examples of suitable epoxy that can be used as the stiffening component are ChipShield 2000 and OptoCast 3400, both available from Jenton International, Hampshire, UK. Another example of a suitable epoxy is UVA4101 available from Star Technology, Waterloo, Ind. Yet another example of a suitable epoxy is LL4001 available from Bondmaster Americas, Bridgewater, N.J.

If curing of the epoxy is an exothermic process, the thermal energy released by the epoxy while curing should not exceed a threshold beyond which the chips 245 or the circuit traces may be damaged. Such threshold can be determined based on the structure of the circuit traces, the structure of the chips 245, the amount of epoxy being cured, the surface area of the epoxy, the environment in which the epoxy is cured, and/or any other parameters that may effect the conduction of thermal energy from the epoxy to the circuit traces and/or the chips 245. Similarly, if curing of the epoxy is an endothermic process, such process should be implemented so as not to damage the circuit traces and the chips 245. For example, if the epoxy is oven cured, the temperature of the oven should not be so high as to damage the chips 245 or to diffuse the circuit traces.

FIG. 4 is another enlarged section view of the display 200 of FIG. 2, taken along section line 3-3. In one aspect of the inventive arrangements, at least one barrier 485 can be placed over the portion 235 of the second layer 210 so as to provide a form for the stiffening component 250 if the stiffening component 250 is initially deposited on the portion 235 while the stiffening component 250 is in a fluidic or semi-fluidic state. The barrier 485 and the portion 235 can define a cavity into which the stiffening component 250 can be deposited. For example, the barrier 485 can comprise one or more walls 490 that form a contiguous enclosure. If plastic, such as epoxy, is deposited in place prior to curing or hardening, the barrier 485 can prevent the plastic from flowing off of the second layer 210. The barrier 485 can be left in place or removed after the plastic is suitably cured or hardened. In an arrangement in which the barrier 485 is left in place, the barrier can become an integral part of the stiffening component 250. The barrier 485 can comprise plastic, fiberglass, paper, or any other suitable material.

In an arrangement in which the display 200 comprises the polarizer layer 215, the stiffening component 250 can be applied prior to the polarizer layer 215 being attached to the first screen layer 205, or after the polarizer layer 215 is attached to the first screen layer 205. In one arrangement, the stiffening component 250 can be self leveling so as to evenly disperse within the area defined by the barrier 485. In another arrangement, after the stiffening component 250 has been deposited onto the portion 235, but has not yet cured or hardened, a squeegee or other suitable tool can be used to level the stiffening component 250 to be substantially even with the top 495 of the barrier 485.

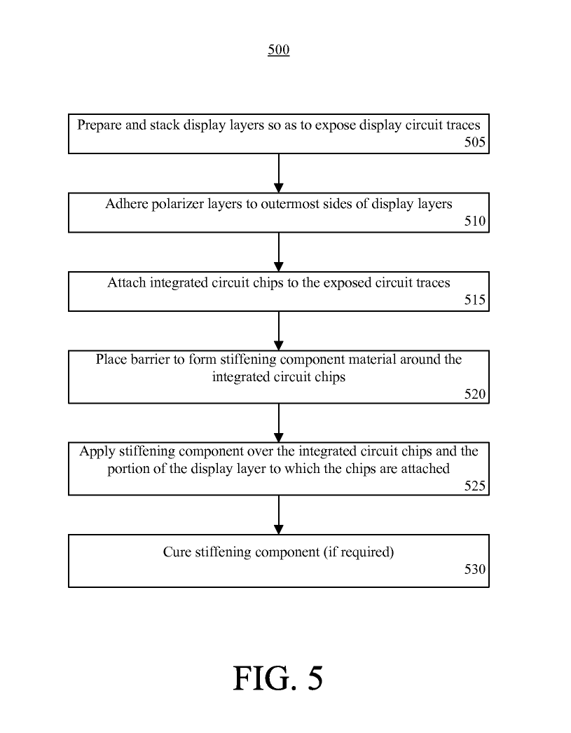

FIG. 5 is a flowchart presenting a method 500 that is useful for understanding the present invention. At step 505, a plurality of display layers can be prepared and stacked. For example, indium titanium oxide circuit traces can be formed on one or more of the display layers and a matrix of liquid crystals can be applied. The display layers then can be stacked such that the circuit traces and the liquid crystal matrix are sandwiched between the opposing display layers. In one arrangement, the display layers can have different dimensions. Thus, after the display layers are stacked, a portion of the circuit traces may remain uncovered. In another arrangement, the display layers may be cut from a larger display layer stack, and thus have the same initial dimensions. A portion of one of the display layers then can be cut away from the display layer stack so as to expose a portion of the circuit traces. At step 510, one or more polarizer layers can be adhered to the outermost sides of the display layers.

Proceeding to step 515, integrated circuit chips can be attached to the exposed circuit traces, for example using an adhesive, such as epoxy. At step 520, a barrier to form the stiffening component material can be placed around the integrated circuit chips. In an alternative arrangement, the barrier can be positioned on the display layer comprising the circuit traces prior to the circuit chips being attached (i.e. step 520 can be performed prior to step 515). A single barrier can be placed so as to extend along an entire edge of a display layer and surround all of the chips, or individual barriers can surround each of the chips. The barrier(s) can be held in place using a fixture or attached to the display layer in a suitable manner.

Continuing to step 525, the stiffening component can be applied over the chips and the portion of the display layer to which the chips are attached. For example, in an arrangement in which the stiffening component is applied while in a fluidic or semi-fluidic state, the stiffening component can be poured or inserted into a region bound by the barrier. In such an arrangement, the process can continue to step 530 and the stiffening component can be cured. For instance, ultraviolet light or thermal energy can be applied to the stiffening component, or the stiffening component can be cured in any other suitable manner.

In an arrangement in which the stiffening component is attached to the chips and or display layer while the stiffening component is in a rigid or semi-rigid state, in lieu of steps 520, 525, 530, a single attachment step can be performed. For example, the stiffening component can be adhered to the display layer with a suitable adhesive.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). As used herein, the terms “substantially” and “approximately” mean within a particular tolerance. Such tolerance can be within 30%, 20%, 10%, 5%, 1%, ½% and so on.

This invention can be embodied in other forms without departing from the spirit or essential attributes thereof. Accordingly, reference should be made to the following claims, rather than to the foregoing specification, as indicating the scope of the invention.

What is claimed is:

1. A display, comprising:
a first screen layer having a first dimension;
a second screen layer having a first side bonded to a first side of the first screen layer, the second screen layer having a second dimension that is greater than the first dimension, thereby defining a portion of the second layer that extends beyond the first layer;
at least one integrated circuit chip attached to the portion of the second layer; and
a stiffening component positioned, at least in part, over the integrated circuit chip.

2. The display of claim 1, wherein the stiffening component is positioned over at least a substantial part of the defined portion of the second layer.

3. The display of claim 2, wherein the integrated circuit chip is encapsulated between the stiffening component and the portion of the second layer.

4. The display of claim 1, wherein the stiffening component has a resistance to bending that is approximately equal to a bending resistance of the first screen layer.

5. The display of claim 1, further comprising:
a barrier attached to the portion of the second layer;
wherein the stiffening component is deposited into a cavity defined by the barrier and the portion of the second layer.

6. The display of claim 5, wherein after the stiffening component is deposited into the cavity, the barrier becomes an integral part of the stiffening component.

7. The display of claim 1, wherein a combination of the first dimension of the first screen layer and a third dimension of the stiffening component is substantially equal to the second dimension of the second screen layer.

8. The display of claim 1, wherein a thickness of the stiffening component is substantially equal to a thickness of the first screen layer.

9. The display of claim 1, further comprising:
a polarizer layer attached to a second side of the first screen layer;
wherein a thickness of the stiffening component is substantially equal to a combined thickness of the first screen layer and the polarizer layer.

10. The display of claim 1, further comprising:
a polarizer layer having a first side attached to a second side of the first screen layer;
wherein the stiffening component has a resistance to bending that is approximately equal to a combined bending resistance of the first screen layer and the polarizer layer.

11. The display of claim 1, wherein the stiffening component comprises epoxy.

12. The display of claim 1, wherein the stiffening component comprises an ultraviolet light curable epoxy.

13. The display of claim 1, wherein the integrated circuit chip comprises a display driver.

14. A display, comprising:
a first screen layer having a first dimension;
a second screen layer having a first side bonded to a first side of the first screen layer, the second screen layer having a second dimension that is greater than the first dimension, thereby defining a portion of the second layer that extends beyond the first layer;
a polarizer layer attached to the first screen layer;
at least one integrated circuit chip attached to the portion of the second layer; and
a stiffening component positioned, at least in part, over the integrated circuit chip, the stiffening component having a resistance to bending that is approximately equal to a combined bending resistance of the first screen layer and the polarizer.

15. A method of fabricating a display, comprising:
positioning a stiffening component, at least in part, over an integrated circuit chip attached to a portion of a second screen layer of a display that comprises a first screen layer and the second screen layer.

16. The method of claim 15, further comprising selecting the stiffening component to have a resistance to bending that is approximately equal to a bending resistance of the first screen layer.

17. The method of claim 15, further comprising:
attaching a barrier attached to a portion of the second layer; and
depositing the stiffening component into a cavity defined by the barrier and the portion of the second layer.

18. The method of claim 15, wherein positioning the stiffening component comprises depositing the stiffening component such that a thickness of the stiffening component is substantially equal to a combined thickness of the first screen layer and a polarizer layer.

19. The method of claim 15, wherein positioning the stiffening component comprises depositing the stiffening component such that a top of the stiffening component is substantially co-planar with respect to a second side of a polarizer layer, the polarizer layer having a first side that is attached to a side of the first screen layer.

20. The method of claim 15, further comprising:
attaching a polarizer layer to the first screen layer; and
selecting the stiffening component to have a resistance to bending that is approximately equal to a combined bending resistance of the first screen layer and the polarizer layer.
